(19) United States
(12) Patent Application Publication
(10) Pub. No.: US 2011/0266302 A1
(43) Pub. Date: Nov. 3, 2011

(54) BEVERAGE AND DESSERT DISPENSER WITH FLOW CONTROL VALVE

(76) Inventor: Robert Masse, St-Jean-Sur-Richelieu (CA)

(21) Appl. No.: 13/095,210

(22) Filed: Apr. 27, 2011

Related U.S. Application Data
(60) Provisional application No. 61/329,638, filed on Apr. 30, 2010.

(51) Int. Cl. B67D 7/06; B65D 47/00; G01F 11/20

(52) U.S. Cl. 222/1; 222/239; 222/561

(57) ABSTRACT

A beverage and dessert dispenser for making beverages or frozen desserts includes an auger driven to rotate and a cone displaceable with respect to the auger such that at least a portion of the auger may be positioned inside the cone for mixing ingredients. A flow control valve, connected to a bottom, exit, end of the cone, includes a housing and a gate operatively connected thereto. The gate is linearly translatable with respect to the housing along a fore-aft axis between closed and open positions of the flow control valve. The flow control valve seals the bottom opening of the cone when in the closed position, and permits fluid flow through the bottom opening of the cone when in the open position. The beverage and dessert dispenser is actuatable between a blending state, where the auger rotates, and a non-blending state, where the auger does not rotate.

### CROSS-REFERENCE TO RELATED APPLICATIONS

The present application claims priority on U.S. provisional patent application No. 61/329,638 filed Apr. 30, 2010, the entire content of which is incorporated herein by reference.

### TECHNICAL FIELD

The present application relates to beverage and/or dessert dispensers including a blending device and, more particularly, to flow control valves which may be used therewith.

### BACKGROUND OF THE ART

Frozen beverage and/or dessert dispensers, such as frozen yogurt mixing machines for example, are often equipped with a blending device in order to mix different ingredients together. During the mixing of ingredients, it is generally desired that the blending device minimize any spillage or leakage of ingredients. As such, beverage and dessert dispensers are often equipped with covers, funnels and/or seals in order to properly receive and/or control the ingredients of the blending device during the mixing thereof.

During the mixing process of a beverage and dessert dispenser, a user may often be required to hold a cup beneath the blending device in order to receive the mixed ingredients therein. This limits the ability of the user to perform other tasks during the mixing process, as well as increases the risk of content leakage/spillage.

Moreover, when using a beverage and dessert dispenser, it may be desired to use both liquid and non-liquid ingredients. However, when both liquid and non-liquid ingredients are mixed in a blending device, the liquid ingredients may seep from the blending device, which leads to an unsatisfactory result.

Therefore, improvements in the art of beverage and dessert dispensers remain desirable.

### SUMMARY OF THE INVENTION

In accordance with the present application, there is provided a beverage and dessert dispenser for making beverages or frozen desserts, the beverage and dessert dispenser comprising: an auger which is driven to rotate; a cone having a top opening at a top end thereof for receiving ingredients therein, a bottom opening at a bottom end thereof, the cone being displaceable with respect to the auger such that at least a portion of the auger may be positioned inside the cone for mixing ingredients received therein; a flow control valve connected to the bottom end of the cone, the flow control valve including a housing and a gate operatively connected to the housing, the gate being linearly translatable with respect to the housing along a fore-aft axis between a closed position of the flow control valve and an open position of the flow control valve, the fore-aft axis being substantially perpendicular to a direction of travel of the cone, the flow control valve sealing the bottom opening of the cone when in the closed position, the flow control valve permitting fluid flow through the bottom opening of the cone when in the open position; and wherein the beverage and dessert dispenser is actuatable between a blending state where the auger rotates and a non-blending state where the auger does not rotate.

In accordance with the present application, there is further provided a method for dispensing content from a beverage and dessert dispenser, the method comprising: providing a flow control valve on a bottom end of a cone of the beverage and dessert dispenser, the flow control valve including a gate translatable within a housing between an open position of the flow control valve and a closed position of the flow control valve, the flow control valve permitting content located inside the cone to flow out of the cone when the flow control valve is in the open position and preventing content located inside the cone from flowing out of the cone when the flow control valve is in the closed position; displacing the gate into the closed position; filling the cone with content; mixing the content of the cone; and displacing the gate into the open position when the content of the cone is mixed, by linearly translating the gate with respect to the housing along a fore-aft axis, to allow the mixed content to flow out of the cone, the beverage and dessert dispenser thereby dispensing mixed content therefrom.

### BRIEF DESCRIPTION OF THE DRAWINGS

FIG. 1 is a front perspective view of a beverage and dessert dispenser in accordance with an embodiment of the present application, having a blending device shown in a non-blending state;

FIG. 2 is a front perspective view of the beverage and dessert dispenser of FIG. 1, having a blending device shown in a blending state and having a flow control valve shown in a closed position;

FIG. 3 is a front perspective view of the beverage and dessert dispenser of FIG. 1, having the flow control valve shown in an open position;

FIG. 4 is a perspective view of the flow control valve in the closed position;

FIG. 5 is a perspective view of a gate of the flow control valve of FIG. 4; and

FIG. 6 is a perspective view of the flow control valve in the open position.

### DETAILED DESCRIPTION

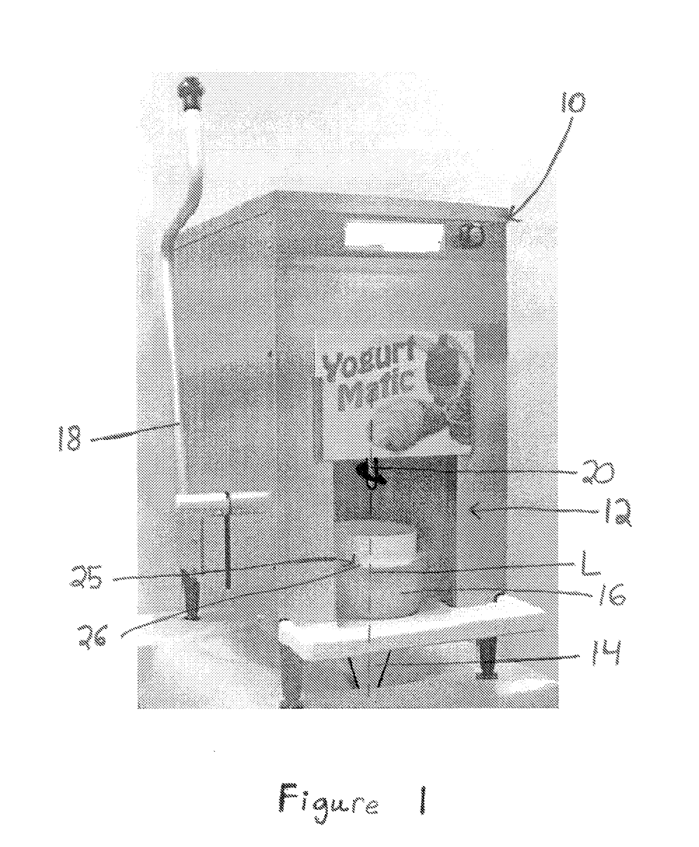

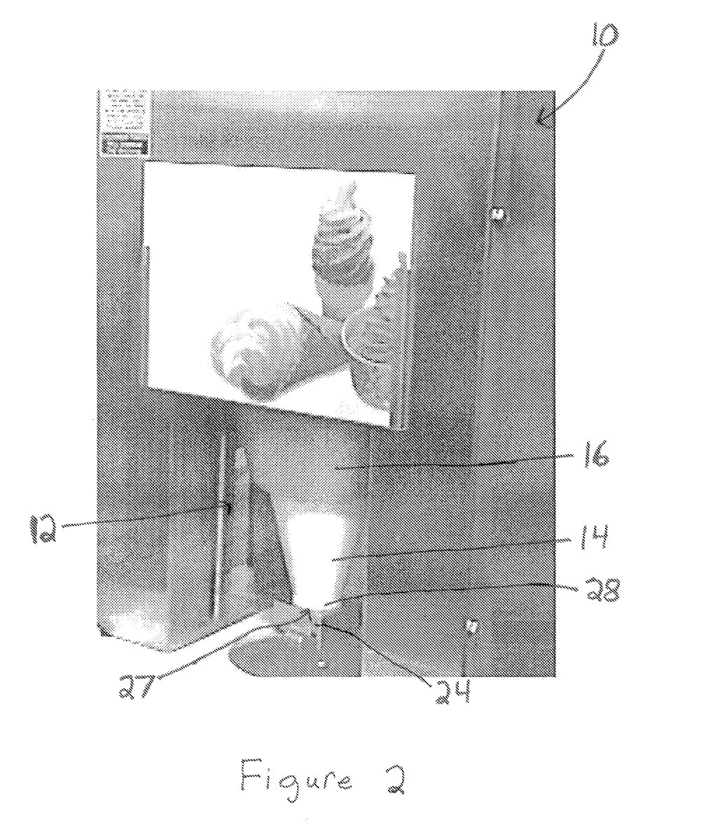

Referring to FIGS. 1-3, a beverage and frozen dessert dispenser is generally illustrated at 10. The beverage and dessert dispenser 10 includes a blending device 12 for mixing various ingredients together.

The blending device 12 comprises a cone 14 for receiving ingredients therein, an auger 20 for mixing the ingredients inside the cone 14 and a flow control valve 24 for controlling the flow of mixed content leaving the cone 14. The cone 14, the auger 20 and the flow control valve 24 are each aligned along a common longitudinal axis L. In the embodiment shown, the longitudinal axis L is substantially vertical, the flow control valve 24 is located at a bottom end 28 of the cone 14, and the auger 20 is generally located above the cone 14 when the blending device 12 is in a non-blending state. In another embodiment, the longitudinal axis L need not be vertical and as such, may be aligned differently with respect to the ground. Furthermore, in another embodiment, the cone 14, the auger 20 and the flow control valve 24 need not always be aligned along a common longitudinal axis.

The cone 14 is connected to, and supported within, a cone holder 16, which circumscribes the cone 14. The cone holder 16 has an annular frusto-conical shape and is used to hold the cone 14 in place. The cone holder 16 is displaced along a pair of vertically extending rails, such that the cone holder, and therefore the cone 14 retained therein, can be moved upward and downwards relative to the auger. The cone 14 includes a top opening 25 at a top end 26 thereof for receiving ingredients therethrough. The cone 14 includes a bottom opening 27 at the bottom end 28 thereof, such that mixed content may pass therethrough. The top opening 25 is larger than the bottom opening 27 of the cone 14 to ease the insertion of ingredients and to better control the content leaving through the bottom opening 27. Furthermore, the top end 26 of the cone 14 has a diameter which is larger than the largest diameter of the cone holder 16, such that the top end 26 of the cone 14 forms a radial lip which extends above and rests on the annular cone holder 16.

The auger 20 is connected to a motor (not shown), which provides power thereto and which drives the auger to rotate about the longitudinal axis L. When the blending device 12 is in a blending state, the auger 20 is actuated to rotate and as such, may be used to mix ingredients. When the blending device 12 is in a non-blending state (as shown in FIG. 1), the auger 20 is not actuated and therefore does not rotate. In another embodiment, the auger 20 may be driven by other means, and as such, need not be connected to a motor.

The flow control valve 24 is connected to the bottom end 28 of the cone 14 and is aligned with the bottom opening 27 of the cone 14. The flow control valve 24 is actuatable between a closed position, wherein the flow control valve 24 seals the bottom opening 27 of the cone 14 such that ingredients may not pass therethrough, and an open position, wherein content may flow through the bottom opening 27.

In use, the cone 14 and the auger 20 are displaceable one with respect to the other, such that the auger 20 may enter the cone 14 and mix content therein. In one embodiment, the cone holder 16 is operatively connected to a lever arm 18, which when the arm 18 is pivoted or rotated, translates the cone holder 16 vertically along axis L. Moreover, when the arm 18 is pivoted or rotated in the opposite direction, the cone holder 16 moves vertically in the opposite direction. It is understood that the cone holder 16 is connected to the cone 14 and so, any displacement of the cone holder 16 involves an equal displacement of the cone 14. In use, the auger 20 may enter the cone 14 through the top opening 25 thereof. The cone 14 may therefore be displaced so as to receive the auger 20 therein. In another embodiment, the cone 14 may be displaced using other means than an arm. In a further embodiment, the cone 14 may remain stationary and the auger 20 may be displaced to enter the cone 14. In yet another embodiment, the cone 14 and the auger 20 may both be displaceable such that both the cone 14 and the auger 20 are displaced towards and away from one another.

In order to mix content located inside the cone 14, the cone 14 is displaced upwards until at least a portion of the auger 20 is located inside the cone 14 and the blending device 12 is actuated into the blending state, i.e. the auger 20 rotates and thereby mixes any content located inside the cone 14. In order to stop mixing content, the cone 14 may be displaced downwards until the auger 20 is no longer located therein or the blending device 12 may be actuated into a non-blending state, i.e. the auger 20 stops rotating. It is understood that when the auger 20 is located inside the cone 14, the cone 14 may be displaced upwards or downwards relative to the auger 20 while still having at least a portion of the auger 20 therein, such that the auger 20 mixes the ingredients inside the cone 14 at different locations of the cone 14 along longitudinal axis L.

Different configurations of the blending device 12 exist for actuating the blending device 12 from a non-blending state into a blending state and vice-versa. In one embodiment, once the auger 20 comes into contact with ingredients inside the cone 14, the auger 20 begins rotating and once it is no longer in contact with ingredients, it stops rotating. In such an embodiment, simply raising or lowering the cone 14 until it circumscribes the auger 20 is sufficient for actuating the blending device 12. In another embodiment, the auger 20 may be driven to rotate independently of the relative location of the cone 14. In such an embodiment, once the auger 20 is located inside the cone 14, the blending device 12 may be actuated using, for example a button, which drives the auger to rotate, the button also being used to stop the rotation of the auger 20. Other such configurations are possible and fall within the scope of the present disclosure.

A removable collar 22 is located over the cone 14. The collar 22 may be used to help reduce any splashing or spillage which may be caused during the mixing of the ingredients inside the cone 14 or during the rinsing thereof. The collar 22 may be connected to the cone 14 using various means known in the art, such as clips, fasteners, etc. In one embodiment, the collar 22 may be removed prior to inserting ingredients into the cone 14, the collar being subsequently placed over the cone 14 once the ingredients have been inserted, prior to placing the blending device in the blending state.

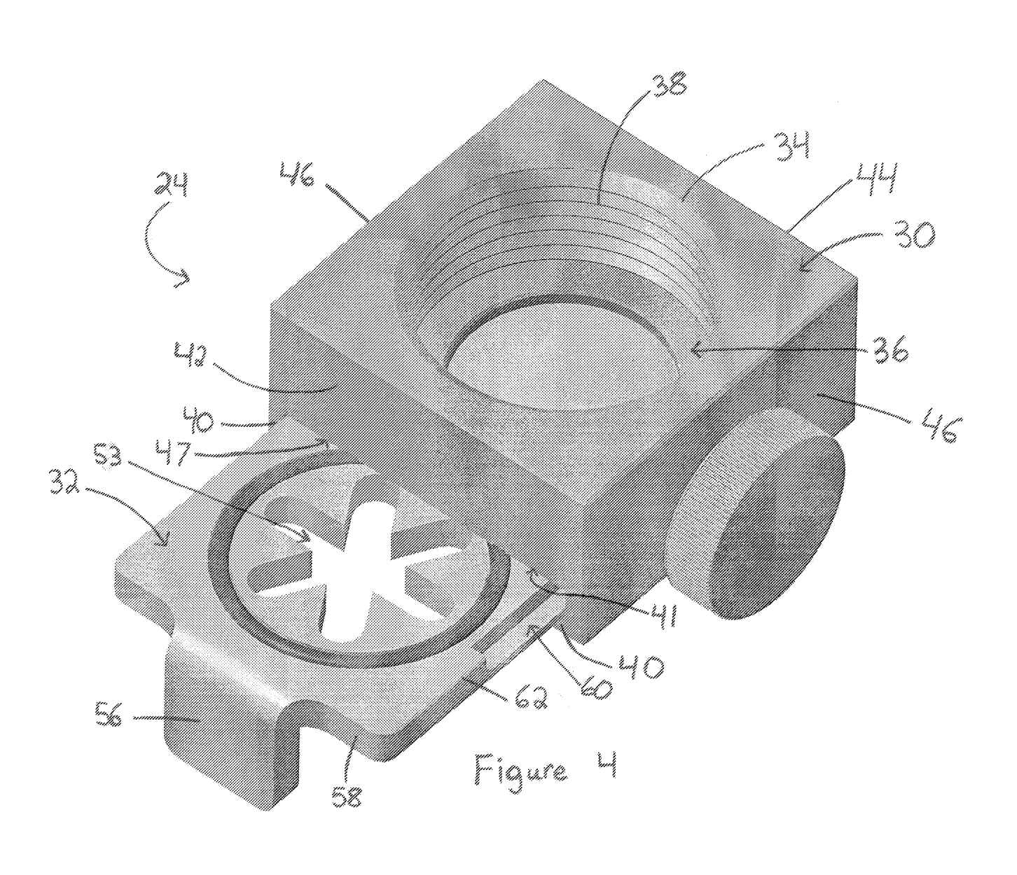

Referring now to FIGS. 4-6, the flow control valve 24 will now be explained in greater detail. As seen in FIG. 4, the flow control valve 24 comprises a housing 30 and a gate 32 operatively connected to the housing 30.

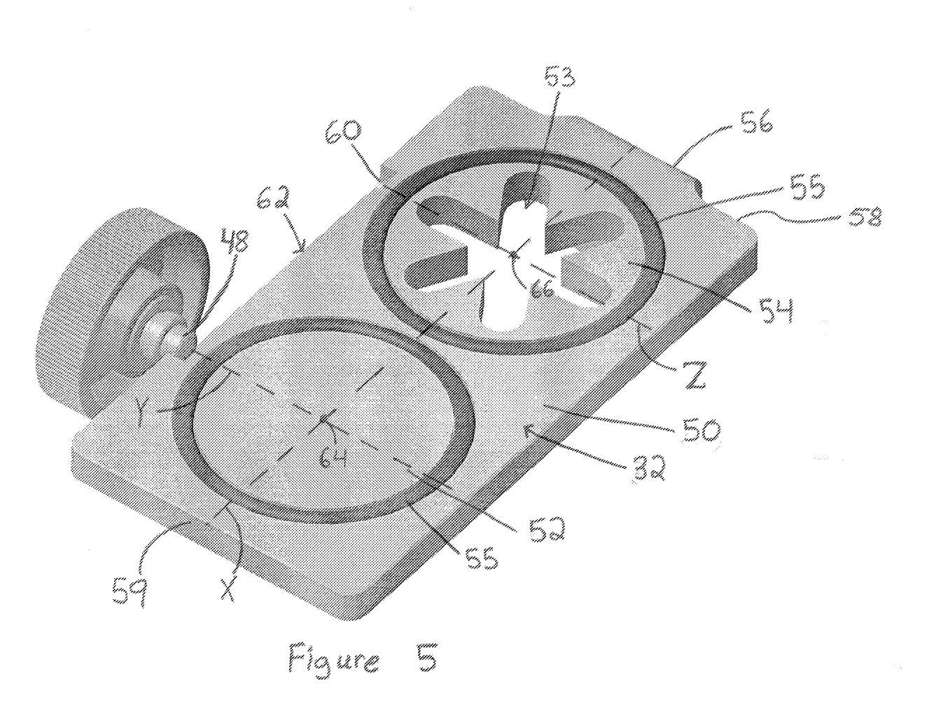

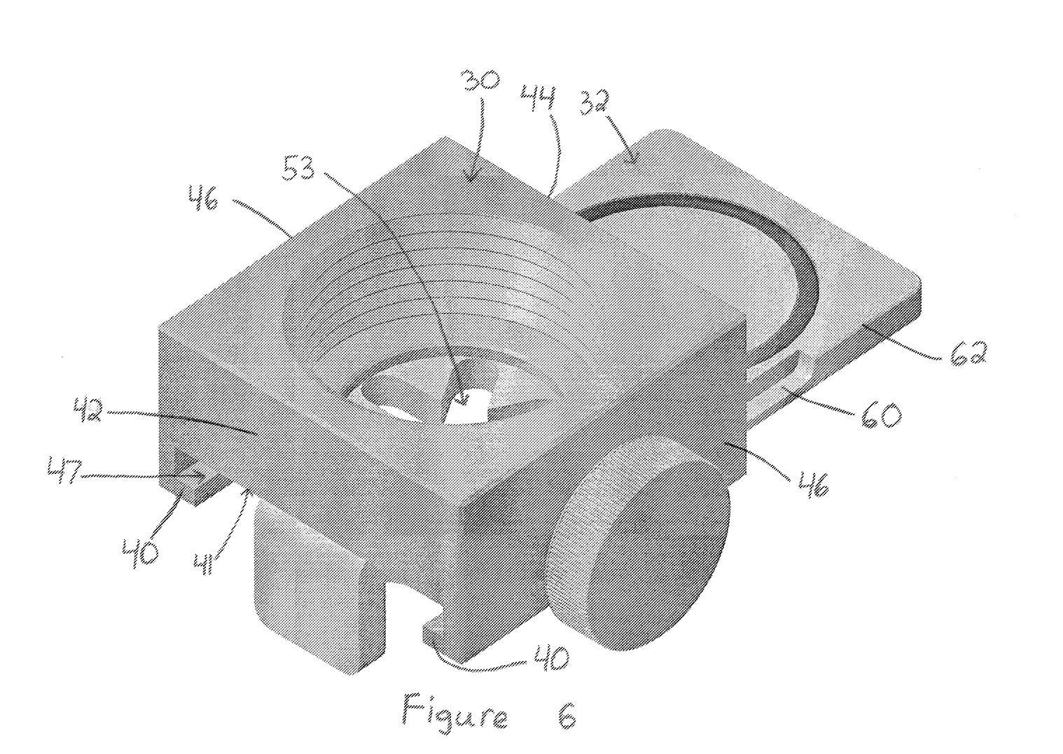

The housing 30 comprises an opening 34 located in a center thereof and passing fully therethrough in a direction corresponding to the longitudinal axis L of the dispenser 10 when the valve 24 is installed in place on the bottom of the cone 14. The opening 34 in the housing 30 creates a cavity 36 therein. In the embodiment shown, a portion of the cavity 36 of the housing 30 has internal threads 38. As best seen in FIG. 6, the housing 30 includes two legs 40 extending from a bottom end 41 of the housing 30 and extending from a front end 42 of the housing 30 to a rear end 44 thereof. The legs 40 are located on opposed lateral sides 46 of the housing 30, and form a slot 47 therebetween. The slot 47 extends through the housing 30 from a front end 42 of the housing 30 to a rear end 44 thereof along the bottom end 41. As seen in FIG. 5, the housing 30 further includes an insert 48 which protrudes through a hole (not shown) in the housing 30 and enters therein. The insert 48 penetrates into the housing 30 at the same elevation as the slot 47, such that the insert 48 protrudes into the slot 47 on a lateral side 46 of the housing 30. Moreover, the insert 48 is aligned with a center of the opening 34 of the housing 30, such that a line leaving the center of the insert 48 passes through the center of the opening 34.

The opening 34 of the housing 30 is aligned with the bottom opening 27 of the cone 14 for dispensing the beverages and/or desserts from the cone 14. In the embodiment shown, the internal threads 38 of the housing 30 are connectable to external threads (not shown) of the bottom end 28 of the cone 14 for connecting the housing 30 thereto. According to different embodiments, the housing 30 need not include internal threads 38, and as such, the housing 30 may be connected to the bottom end 28 of the cone 14 using various means, such as fasteners, clasps, adhesives, etc.

The gate 32 is located inside the slot 47 of the housing 30 and is displaceable therein with respect to the housing 30. The gate 32 forms a generally elongated plate which slides inside the slot 47. As seen in FIG. 5, the gate 32 comprises an upper surface 50 having a solid un-pierced portion 52 and an open portion 54, the solid un-pierced portion 52 being spaced apart from the open portion 54. The open portion 54 forms a hole 53 through the gate 32. The solid portion 52 and the open portion 54 are each surrounded by circular slots (not shown) formed in the upper surface 50 of the gate 32, each circular slot receiving an o-ring 55 therein. The o-rings 55 abut the bottom end 41 of the housing 30 so as to seal the upper surface 50 of the gate 32 against the bottom end 41 of the housing 30. In a situation where content leaks between the gate 32 and the bottom end 41 of the housing 30, the o-rings 55 prevent the leakage from exiting the flow control valve 24, and so maintain cleanliness.

As seen in FIG. 4, the gate 32 includes a handle 56 on a front periphery 58 thereof. The handle 56 may be used to push or pull the gate 32 within the slot 47 for translation with respect to the housing 30. The gate 32 further includes a lateral slot 60 located on a side peripheral edge 62 of the gate 32. The slot 60 extends only a portion of the distance from the front periphery 58 to a rear periphery 59 of the gate 32. The insert 48 extends through the housing 30 and into the slot 60, so as to limit the translation of gate 32.

As seen in FIGS. 5-6, the gate 32 forms a generally elongated plate which is substantially rectilinear, with an axis X extending from the front periphery 58 to the rear periphery 59 of the gate 32 and which passes through a center 64 of the solid un-pierced portion 52 and a center 66 of the open portion 54. Furthermore, an axis Y extends from the center 64 of the solid un-pierced portion 52 in a direction perpendicular to axis X and an axis Z extends from the center 66 of the open portion 54 in a direction perpendicular to axis X and parallel to axis Y. The slot 60 in the gate 32 extends from a position located a distance equivalent to the radial size of the insert 48 beyond the axis X to an opposite position located a distance equivalent to the radial size of the insert 48 beyond the axis Y.

Therefore, in a first position as seen in FIG. 4, the insert 48 is aligned with the center 64 of the solid un-pierced portion 52, and as such, the solid un-pierced portion 52 is coaxial with the opening 34 in the housing 30. In this first position, the solid un-pierced portion 52 closes the opening 34 in the housing 30 and as such, defines a closed position of the flow control valve 24. In a second position as seen in FIG. 6, the insert 48 is aligned with the center 66 of the open portion 54, and as such, the open portion 54 is coaxial with the opening 34 in the housing 30. In this second position, the open portion 54 permits content to flow through the housing 30 and the gate 32, and as such, defines an open position of the flow control valve 24. It is therefore possible to operate the flow control valve 24 between an open and a closed position by pushing or pulling on the handle 56, thereby translating the gate 32 in a rectilinear direction along the fore-aft axis X.

By using the flow control valve 24, it becomes possible to control the flow of content leaving the cone 14. When the flow control valve 24 is in a closed position (FIG. 4), the beverage and dessert dispenser 10 does not dispense content because the flow control valve 24 blocks the flow of content exiting the cone 14 through the bottom opening 27. When the flow control valve 24 is in an open position (FIG. 6), the beverage and dessert dispenser 10 may dispense content because the flow control valve 24 allows content to flow through the bottom opening 27 of the cone 14, through the opening 34 in the housing 30 and through the open portion 54 of the gate 32.

The gate 32 and the slot 47 of the housing 30 are configured such that the gate 32 may easily be displaced inside the slot 47 and yet forms a seal with the bottom end 41 of the housing 30. This ensures that any leakage in the flow control valve 24 between the housing 30 and the gate 32 is minimized.

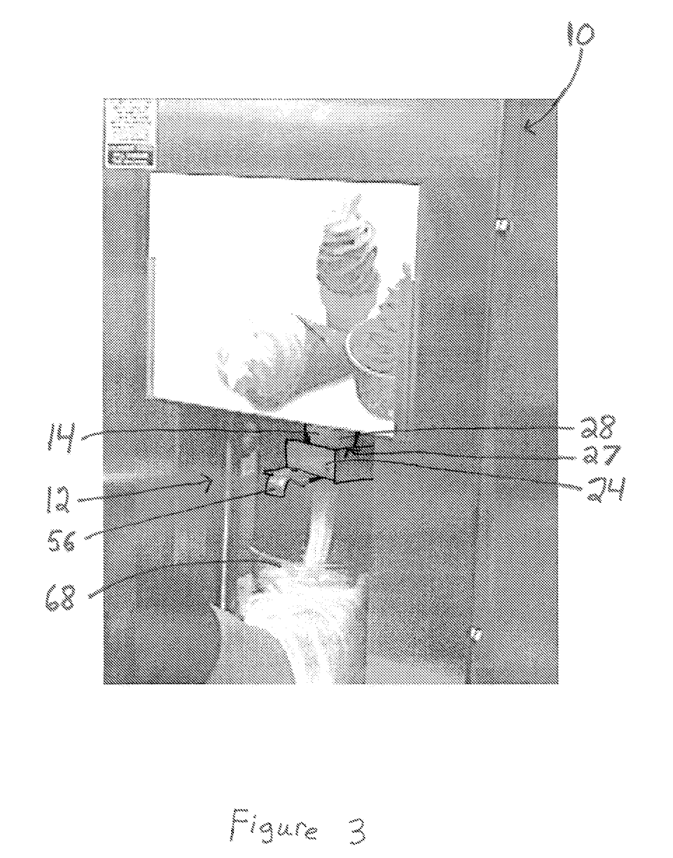

In order to dispense beverage or dessert from the beverage and dessert dispenser 10, the flow control valve 24 should initially be placed in the closed position, the blending device 12 should be in the non-blending state and the cone 14 should be displaced away from the auger 20. A user may then insert ingredients into the cone 14 through the top opening 25 thereof. Once all the desired ingredients have been placed in the cone 14, the collar 22 may be placed over the cone holder 16. The cone 14 may be raised until at least a portion of the auger 20 enters the cone 14, and the blending device 12 may then be actuated into the blending state, i.e., the auger 20 may be driven to rotate. Once the ingredients have been sufficiently mixed, the blending device 12 may be placed in the non-blending state, i.e. the auger 20 is stopped. As seen in FIG. 3, a container 68 may then be placed below the opening 34 in the housing 30 and the flow control valve 24 may be placed in the open position, such that mixed content flows from the cone 14 into the container 68. Alternatively, once the flow control valve 24 is placed in the open position, the blending device 12 may be actuated and the auger 20 may rotate, which forces the mixed content to flow more rapidly into the container 68. It is understood that various containers, such as cups, cones, bowls, etc. may be used to receive mixed content from the beverage and dessert dispenser 10.

It is therefore possible to provide a beverage and dessert dispenser 10 for which the dispensing of mixed content therefrom is controlled and does not require a user to hold a container thereunder during the mixing of the ingredients.

In one embodiment, the insert 48 forms a portion of a dial which is geared and the slot 60 includes teeth, such that the dial and the slot 60 may be used as a rack and pinion system for displacing the gate 32. In another embodiment, the insert 48 may be any type of component which may be inserted into a hole, for example, the insert 48 may be a shaft, an elongated member, etc. Moreover, an insert 48 may be provided which is completely inserted into the hole in the housing 30 so as to protrude into the slot 47, but which does not protrude on the lateral side 46 of the housing 30.

An advantage of the flow control valve 24 is that the gate 32 is readily disconnectable from the housing 30, in order to provide customized flow configurations and/or to permit removal or replacement for other purposes, such as cleaning, repair, etc. When removal of the gate 32 from the housing 30 is desired, the insert 48 can simply be unscrewed or otherwise removed from inside the slot 47 in the housing 30 and from inside the slot 60 in the gate 32. Once the insert 48 is removed, the gate 32 may be slid out from inside the slot 47. The flow control valve 24 may therefore be customized by providing various alternate gates 32 therein, for example, the gate 32 may be replaced by other gates having a differently-sized and/or differently shaped hole 53 in the open portion 52 thereof. In the embodiment shown, the open portion 52 includes a hole 53 which has a star shape, but in other embodiments, the open portion 52 may include a hole of any other shape desired for customized dispensing of dessert or beverage therethrough. Alternatively, the open portion 52 may include a plurality of holes 53, and the holes 53 may form various patterns. Moreover, the gate 32 may be removed independently from the housing 30 in order to clean the gate 32, if desired. The insert 48 may be threaded such that it may be screwed into the housing 30. In this embodiment, the insert 48 may be removed from the housing 30 simply by turning the insert 48 and so, unscrewing it therefrom.

In an alternate embodiment, the flow control valve 24 may be disconnected entirely from the cone 14. As such, the blending device 12 may be customized to have different types of flow control valves at a bottom thereof, as desired. A user may simply disconnect the flow control valve 24 from the cone 14 and then connect a different flow control valve in its place. Furthermore, the flow control valve 24 may be disconnected from the cone 14 for cleaning thereof.

The beverage and dessert dispenser 10 may be used to prepare a variety of beverages and/or desserts. For example, the beverage and dessert dispenser 10 may be used to prepare milkshakes, malts, smoothies, shakes, cocktails, as well as ice cream, frozen yogurt, etc. The blending device 12 may receive a number of different ingredients which enter the composition of the afore-mentioned beverages and desserts. For example, the blending device 12 may receive fruits, vegetables, chocolate, candy, milk, cream, juices, ice cream, yogurt, etc, whether frozen or not. These ingredients may then be mixed by the auger 20, inside the cone 14. An advantage of using the flow control valve 24 with the beverage and dessert dispenser 10 is that both liquid and non-liquid ingredients may be used in the cone 14. Where previously liquid ingredients would often seep out of the cone 14, the flow control valve 24 may be operated in the closed position in order to prevent liquid ingredients from exiting the cone 14 during the mixing thereof.

The above description is meant to be exemplary only, and one skilled in the art will recognize that changes may be made to the embodiments described without departing from the scope of the invention disclosed. For example, the invention may be used not only with beverage and dessert dispensers which include a blending device, but additionally with other types of beverage and/or dessert dispensers. Still other modifications which fall within the scope of the present invention will be apparent to those skilled in the art, in light of a review of this disclosure, and such modifications are intended to fall within the appended claims.

1. A beverage and dessert dispenser for making beverages or frozen desserts, the beverage and dessert dispenser comprising:
an auger which is driven to rotate;
a cone having a top opening at a top end thereof for receiving ingredients therein, a bottom opening at a bottom end thereof, the cone being displaceable with respect to the auger such that at least a portion of the auger may be positioned inside the cone for mixing ingredients received therein;
a flow control valve connected to the bottom end of the cone, the flow control valve including a housing and a gate operatively connected to the housing, the gate being linearly translatable with respect to the housing along a fore-aft axis between a closed position of the flow control valve and an open position of the flow control valve, the fore-aft axis being substantially perpendicular to a direction of travel of the cone, the flow control valve sealing the bottom opening of the cone when in the closed position, the flow control valve permitting fluid flow through the bottom opening of the cone when in the open position; and
wherein the beverage and dessert dispenser is actuatable between a blending state where the auger rotates and a non-blending state where the auger does not rotate.

2. The beverage and dessert dispenser according to claim 1, wherein the housing includes an opening therethrough, the opening in the housing being aligned with the bottom opening of the cone when the flow control valve is connected to the bottom end of the cone.

3. The beverage and dessert dispenser according to claim 2, wherein the gate includes an open portion at a first location thereof and a solid un-pierced portion at a second location thereof, the open portion of the gate being aligned with the opening in the housing when the flow control valve is in the open position, the solid un-pierced portion of the gate being aligned with the opening in the housing when the flow control valve is in the closed position.

4. A method for dispensing content from a beverage and dessert dispenser, the method comprising:
providing a flow control valve on a bottom end of a cone of the beverage and dessert dispenser, the flow control valve including a gate translatable within a housing between an open position of the flow control valve and a closed position of the flow control valve, the flow control valve permitting content located inside the cone to flow out of the cone when the flow control valve is in the open position and preventing content located inside the cone from flowing out of the cone when the flow control valve is in the closed position;
displacing the gate into the closed position;
filling the cone with content;
mixing the content of the cone; and
displacing the gate into the open position when the content of the cone is mixed, by linearly translating the gate with respect to the housing along a fore-aft axis, to allow the mixed content to flow out of the cone, the beverage and dessert dispenser thereby dispensing mixed content therefrom.

5. The method according to claim 4, wherein the method further comprises placing a collar on the cone holder.
